(19) United States
(12) Patent Application Publication
(10) Pub. No.: US 2026/0011894 A1
(43) Pub. Date: Jan. 8, 2026

(54) ELECTRODE, ELECTRODE ASSEMBLY AND METHOD OF MANUFACTURING ELECTRODE ASSEMBLY

(71) Applicant: SAMSUNG SDI CO., LTD., Yongin-Si Gyeonggi-do (KR)

(72) Inventor: Minseung KANG, Yongin-Si (KR)

(21) Appl. No.: 19/087,145

(22) Filed: Mar. 21, 2025

(30) Foreign Application Priority Data
Jul. 5, 2024 (KR) 10-2024-0089047

(51) Int. Cl. H01M 50/595; H01M 10/04; H01M 50/586

(52) U.S. Cl. CPC H01M 50/595; H01M 10/0431; H01M 50/586

(57) ABSTRACT

An electrode may include a substrate, a coated portion including an active material on opposite sides of the substrate, a non-coated portion at a tip of the substrate where the opposite sides of the substrate are exposed, and a semi-coated portion between the coated portion and the non-coated portion, and comprising the active material on one side of the substrate, in which a protective tape may be attached to the other side of the substrate in which the substrate is exposed in the semi-coated portion.

### CROSS-REFERENCE TO RELATED APPLICATION

The present application claims priority to and the benefit of Korean Application No. 10-2024-0089047, filed on Jul. 5, 2024, in the Korean Intellectual Property Office, the entire disclosure of which is incorporated herein by reference.

### BACKGROUND

### 1. Field

Embodiments of the present disclosure described herein are related to an electrode, an electrode assembly, and a method of manufacturing the electrode assembly.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Electrode assemblies may be divided into stacked electrode assemblies and wound electrode assemblies. In the case of the wound electrode assembly, electrodes and separators are alternately laminated and wound around a core that is the center of winding, and then the core is extracted to complete the electrode assembly. In this case, there is a problem that wrinkles occur in the substrate located at the center of winding during a process of extracting the core from the electrode assembly.

The above information disclosed in this Background section is for enhancement of understanding of the background of the present disclosure, and therefore, it may contain information that does not constitute related (or prior) art.

### SUMMARY

Aspects according to one or more aspects of embodiments are directed toward an electrode, an electrode assembly, and a method of manufacturing the electrode assembly.

These and other aspects and features of the present disclosure will be described in or will be apparent from the following description of embodiments of the present disclosure.

According to some embodiments of the present disclosure, an electrode includes a substrate, a coated portion including an active material on both sides (e.g., opposite sides) of the substrate, a non-coated portion at a tip of the substrate, and where both sides (opposite sides) of the substrate are exposed, and a semi-coated portion between the coated portion and the non-coated portion, and including the active material on one side of the substrate, in which a protective tape may be attached to the other side of the substrate where the substrate is exposed in the semi-coated portion.

According to some embodiments of the present disclosure, a folding line along which the substrate is configured to be first folded may be positioned on the semi-coated portion, and a protective tape may be attached to cover the folding line.

According to some embodiments of the present disclosure, the protective tape may be attached to cover an area less than or equal to 10 mm on each side of the folding line in a longitudinal direction of the electrode.

According to some embodiments of the present disclosure, the protective tape may be attached to cover an area less than or equal to 5 mm on each side of the folding line in a longitudinal direction of the electrode.

According to some embodiments of the present disclosure, an end line in which an end of another substrate facing the substrate is located may be in the semi-coated portion, and a protective tape may be attached to cover the end line.

According to some embodiments of the present disclosure, the protective tape may be spaced from the coated portion.

According to some embodiments of the present disclosure, the protective tape may be spaced from the coated portion by 10 mm or more.

According to some embodiments of the present disclosure, an insulating tape may be on the other side of the substrate in which the substrate is exposed in the semi-coated portion between the protective tape and the coated portion.

According to some embodiments of the present disclosure, a substrate tab may be connected to a non-coated portion, and a protective tape may be attached to cover the substrate tab.

According to some embodiments of the present disclosure, at least a portion of the protective tape may include (e.g., may be composed of) an insulating material.

According to some embodiments of the present disclosure, at least a portion of the protective tape may include (e.g., may be composed of) a polyimide (PI) material or a polyethylene terephthalate (PET) material.

According to some embodiments of the present disclosure, an electrode assembly includes a first electrode, a second electrode, and a separator that is between the first electrode and the second electrode, wherein the first electrode, the separator, and the second electrode are wound in a sequentially stacked state, the first electrode includes a substrate, a coated portion including an active material on both sides (e.g., opposite sides) of the substrate, a non-coated portion at a tip of the substrate, and where the both sides (e.g., opposite sides) of the substrate are exposed, and a semi-coated portion between the coated portion and the non-coated portion, and including the active material on one side of the substrate, and a protective tape may be attached to the other side of the substrate in which the substrate is exposed in the semi-coated portion.

According to some embodiments of the present disclosure, a folding line along which the substrate is configured to be first folded may be located in the semi-coated portion, and a protective tape may be attached to cover the folding line.

According to some embodiments of the present disclosure, the protective tape may be attached to cover an area less than or equal to 10 mm on each side of the folding line in the longitudinal direction of the electrode.

According to some embodiments of the present disclosure, an end line in which an end of the second electrode facing the first electrode is located may be in the semi-coated portion, and a protective tape may be attached to cover the end line.

According to some embodiments of the present disclosure, a substrate tab may be connected to a non-coated portion of a first electrode, and a protective tape may be attached to cover the substrate tab.

According to some embodiments of the present disclosure, a method of manufacturing an electrode assembly includes: preparing an electrode laminate in which a first electrode, a separator, and a second electrode are sequentially stacked; winding the electrode laminate from a tip of the electrode laminate to form a wound electrode laminate; and pressing the wound electrode laminate in a direction perpendicular to the winding surface, in which the first electrode includes a substrate, a coated portion including an active material on both sides (e.g., opposite sides) of the substrate, a non-coated portion at a tip of the substrate, and where the both sides (e.g., opposite sides) of the substrate are exposed, and a semi-coated portion between the coated portion and the non-coated portion, and including the active material on one side of the substrate, and attaching a protective tape to the other side of the substrate in which the substrate is exposed in the semi-coated portion, before the preparing the electrode laminate.

According to some embodiments of the present disclosure, in the winding of the electrode assembly, a folding line along which the substrate is first folded may be on the semi-coated portion of the first electrode, and a protective tape may be attached to cover the folding line.

According to some embodiments of the present disclosure, in the preparing of the electrode laminate, an end line in which an end of a second electrode facing the first electrode is located may be in the semi-coated portion, and a protective tape may be attached to cover the end line.

According to some embodiments of the present disclosure, a substrate tab may be connected to a non-coated portion of a first electrode, and a protective tape may be attached to cover the substrate tab.

### Effect of Invention

According to some embodiments of the present invention, the stability and life characteristics of a secondary battery may be improved by preventing or reducing the occurrence of wrinkles or folds in a semi-coated portion at the center of winding during a core extraction process or a pressing process of an electrode assembly by using a protective tape.

According to some embodiments of the present invention, the protective tape may be attached to cover not only the folding line along which the substrate is first folded, but also the end line where an end of another substrate is on the substrate. Accordingly, the insulating tape may not be provided, the tape attachment process is simplified, and the cost of the secondary battery manufacturing process may be reduced.

According to some embodiments of the present invention, the protective tape may be attached to cover not only a folding line (F) where the substrate is first folded, but also the substrate tab connected to the substrate.

According to some embodiments of the present invention, the substrate tab protective tape is not provided, so that the tape attachment process is simplified and the cost of the secondary battery manufacturing process may be reduced.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a drawing showing an example of a battery cell according to one or more embodiments of the present disclosure.

FIG. 2 is a drawing showing a comparative example of electrodes according to one or more embodiments of the present disclosure.

FIG. 3 is a drawing showing an example of an electrode according to one or more embodiments of the present disclosure.

FIG. 4 is an enlarged view of a protective tape illustrated in FIG. 3 according to one or more embodiments of the present disclosure.

FIG. 5 is a drawing showing an example of an electrode according to one or more embodiments of the present disclosure.

FIG. 6 is an enlarged view of a protective tape illustrated in FIG. 5 according to one or more embodiments of the present disclosure.

FIG. 7 is a drawing showing an example of an electrode according to one or more embodiments of the present disclosure.

FIG. 8 is an enlarged view of a protective tape illustrated in FIG. 7 according to one or more embodiments of the present disclosure.

FIG. 9 is a flowchart illustrating a method of manufacturing an electrode assembly according to one or more embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In this disclosure, the sizes and relative sizes of layers and regions illustrated in the drawings may be exaggerated for clarity of explanation. For example, the sizes shown in the drawings are only for convenience of understanding and are not limited thereto. In addition, identical reference numerals throughout the specification refer to identical components.

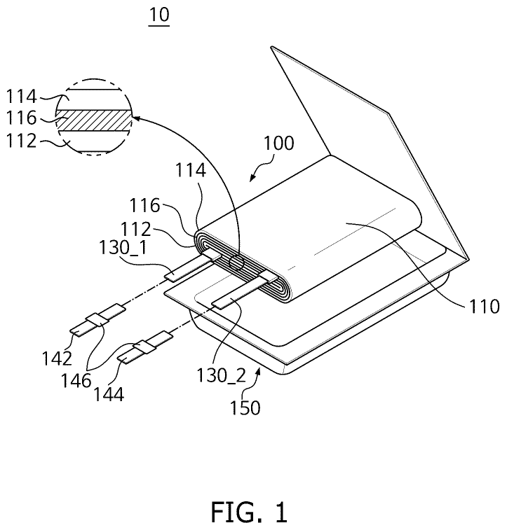

FIG. 1 is a diagram showing an example of a battery cell 10 according to one or more embodiments of the present disclosure. As illustrated, the battery cell 10 may include a case 150 and an electrode assembly 100 inside the case 150.

The electrode assembly 100 may include an electrode laminate 110. The electrode laminate 110 may include a first electrode 112, a second electrode 114, and a separator 116 interposed therebetween. The first electrode 112 and the second electrode 114 may be wound with the separator 116, which is an insulator, interposed therebetween. The first electrode 112 of the electrode laminate 110 may function as a cathode, and the second electrode 114 may function as an anode. In one or more embodiments, the opposite is also possible. For example, the first electrode 112 of the electrode laminate 110 may function as an anode, and the second electrode 114 may function as a cathode.

The first electrode 112 is formed by applying an active material such as graphite or carbon to a substrate including (e.g., formed of) a metal foil such as copper, a copper alloy, nickel or a nickel alloy, and may include a non-coated portion which is an area where the active material is not applied. The first substrate tab 130_1 may be connected to the non-coated portion of the first electrode 112. The first substrate tab 130_1 may be a current flow path between the first electrode 112 and the first lead tab 142. A tab film 146 for insulation from the case 150 may be attached to the first lead tab 142.

The second electrode 114 is formed by applying an active material such as a transition metal oxide to a substrate including (e.g., formed of) a metal foil such as aluminum or an aluminum alloy, and may include a non-coated portion which is an 1 area where the active material is not applied. A second substrate tab 130_2 may be connected to the non-coated portion of the second electrode 114. The second substrate tab 130_2 may be a current flow path between the second electrode 114 and the second lead tab 144. A tab film 146 for insulation from the case 150 may be attached to the second lead tab 144.

The case 150 may form the overall appearance of the battery cell 10 and may include (e.g., may be made of) a conductive metal such as aluminum, an aluminum alloy, or nickel-plated steel. In addition, the case 150 may provide a space in which the electrode laminate 110 is accommodated.

In FIG. 1, the case 150 is shown as a pouch-type case and the battery cell 10 is shown as a pouch-type battery cell, but the scope of the present disclosure is not limited thereto. The battery cell 10 may be a battery cell of any shape, such as a square shape, a cylindrical shape, or a pouch shape.

The battery cell 10 may be a type of secondary battery. For example, the battery cell 10 may be a lithium battery cell, a sodium battery cell, or the like. However, the scope of the present disclosure is not limited thereto, and the battery cell 10 may include all batteries that may repeatedly provide electricity by charging and discharging.

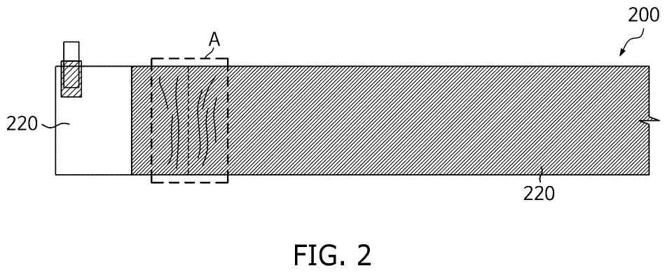

FIG. 2 is a drawing showing a comparative example of electrodes 200 according to one or more embodiments of the present disclosure.

The electrode 200 may include a coated portion 210 in which an active material is applied to both sides (e.g., opposite sides) of the substrate. An non-coated portion 220 in which the active material is not applied and both sides (e.g., opposite sides) of the substrate are exposed (e.g., does not have the active material) may be formed on the tip of the substrate in the longitudinal direction of the electrode 200. A semi-coated portion, in which only one side of the substrate is coated with the active material, may be formed between the coated portion 210 and the non-coated portion 220.

In one or more embodiments, the electrodes 200 may be alternately stacked with the separators to form a wound electrode assembly. For example, the wound electrode assembly may include electrodes 200 alternately stacked with the separators. In the case of the wound electrode assembly, the electrodes and the separators are alternately laminated and wound around a core that is the center of the winding, and then the core is extracted to complete the electrode assembly. In this case, there is a problem of wrinkles occurring near the tip of the substrate at the center of the winding as the tension at the center of the winding of the electrode assembly decreases (e.g., rapidly decreases) during the core extraction process. Referring to the display area (A), it may be checked or determined that wrinkles have occurred near the tip of the electrode 200.

In addition, the electrode assembly from which the core has been extracted may undergo a process of being pressed in a direction perpendicular to the winding surface. In this case, there is a problem of the substrate being folded near the tip and generating a folding line. For example, when the folding line is in a portion coated with an active material (for example, the coated portion 210 or a semi-coated portion), there is a problem of reducing the battery capacity.

Electrode structures according to some embodiments to prevent or reduce the occurrence of wrinkles or folds near the tip of the substrate will be described in more detail below.

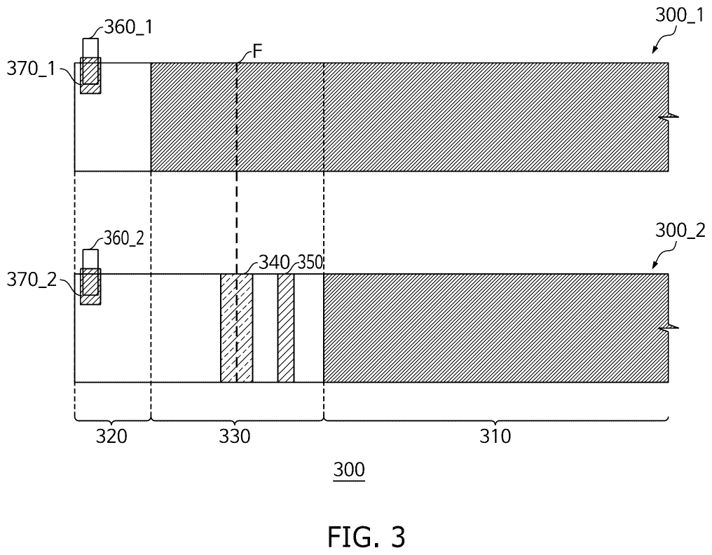

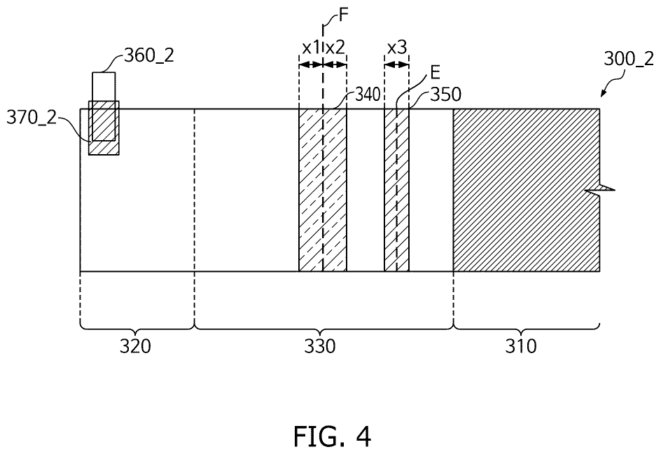

FIG. 3 is a diagram showing an example of the electrode 300 according to one or more embodiments of the present disclosure, and FIG. 4 is an enlarged view of the protective tape 340 shown in FIG. 3 according to one or more embodiments of the present disclosure. Referring to FIGS. 3 and 4, the electrode 300 may be formed by applying an active material to both sides (e.g., opposite sides) of a substrate. In one or more embodiments, the areas where the active material is applied to one side 300_1 and the other side 300_2 of the substrate may be different from each other. For example, an area where the active material is not applied thereto and the substrate is exposed may be formed at the tips of the one side 300_1 and the other side 300_2 of the substrate, and in the longitudinal direction of the substrate, the length of an area where the substrate is exposed at the tip of the one side 300_1 of the substrate may be shorter than the length of an area where the substrate is exposed at the tip of the other side 300_2 of the substrate.

Accordingly, the electrode 300 may include a coated portion 310 in which an active material is applied to both sides (e.g., opposite sides) of the substrate, a semi-coated portion 330 in which the active material is applied to only one side of the substrate, and a non-coated portion 320 in which active material is not applied to the both sides (e.g., opposite sides) of the substrate. The non-coated portion 320 may be at the tip of the substrate. The semi-coated portion 330 may be between the coated portion 310 and the non-coated portion 320. For convenience of explanation, with respect to the semi-coated portion 330 in the drawing, a direction in which the coated portion 310 is arranged is defined as the right side and a direction in which the non-coated portion 320 is arranged is defined as the left side. For example, the uncoated portion 320 may be referred to as the left side and the coated portion 310 may be referred to as the right side.

In one or more embodiments, a protective tape 340 may be attached to the other side 300_2 of the substrate in the semi-coated portion 330. The protective tape 340 may be attached to cover at least a portion of the other side 300_2 of the substrate in the semi-coated portion 330, and may also be attached to cover the entire semi-coated portion 330.

In one or more embodiments, the electrodes 300 may be alternately stacked with the separators to form a wound electrode assembly. The electrode 300 is wound from the tip of the substrate, and the wound electrode assembly may be pressed in a direction perpendicular to the winding surface. In this case, as the electrode assembly is pressurized, a folding line (F) may be formed near the tip of the substrate where the substrate is first folded, and the folding line (F) may be located on the semi-coated portion 330 of the substrate.

In one or more embodiments, the protective tape 340 may be attached to cover the folding line (F). The protective tape 340 may be attached to cover an area within a set or certain length on each side of the folding line (F) in the longitudinal direction of the electrode. For example, the protective tape 340 may be attached to cover an area of a first length (x1) to the left of the folding line (F) and to cover an area of a second length (x2) to the right of the folding line (F). The first length (x1) and the second length (x2) may each be less than or equal to 10 mm. Additionally, the first length (x1) and the second length (x2) may each be less than or equal to 5 mm. Here, the first length (x1) and the second length (x2) may be equal to or different from each other.

In one or more embodiments, at least a portion of the protective tape 340 may include (e.g., may be composed of) an insulating material. For example, at least a portion of the protective tape 340 may include (e.g., may be composed of) a material such as polyethylene terephthalate (PET) or polyimide (PI), but is not limited thereto.

In one or more embodiments, the electrode 300 is a cathode and the substrate may be a cathode substrate, but is not limited to.

In one or more embodiments, an insulating tape 350 may be attached to the other side 300_2 of the substrate in the semi-coated portion 330. An end line (E) on which an end of another substrate facing the corresponding substrate is arranged may be in the semi-coated portion 330, and an insulating tape 350 may be attached to cover the end line (E). The length (x3) of the insulating tape 350 may be less than or equal to 10 mm, but is not limited thereto.

In one or more embodiments, the insulating tape 350 may be attached to cover an area within a set or certain length on each side of the end line (E). For example, the insulating tape 350 may be attached to cover an area within 5 mm on each side of the end line (E), but is not limited thereto.

In one or more embodiments, the non-coated portion 320 may be connected to substrate tabs 360_1 and 360_2, and substrate tab protective tapes 370_1 and 370_2 may be attached to the substrate tabs 360_1 and 360_2. For example, a first substrate tab 360_1 may be connected to one side 300_1 of the substrate of the non-coated portion 320, and a first substrate tab protective tape 370_1 may be attached to the first substrate tab 360_1. In addition, a second substrate tab 360_2 may be connected to the other side 300_2 of the substrate of the non-coated portion 320, and a second substrate tab protective tape 370_2 may be attached to the second substrate tab 360_2.

In one or more embodiments, the first substrate tab 360_1 may be connected to overlap on one side 300_1 of the substrate, and the first substrate tab protective tape 370_1 may be attached to cover the area where the first substrate tab 360_1 and the one side 300_1 of the substrate overlap. For example, the first substrate tab protective tape 370_1 may be formed to be larger than the area where the first substrate tab 360_1 and one side of the substrate 300_1 overlap each other, so as to protrude beyond the area.

Similarly, the second substrate tab 360_2 may be connected to overlap on the other side 300_2 of the substrate, and the second substrate tab protective tape 370_2 may be attached to cover the area where the second substrate tab 360_2 and the other side 300_2 of the substrate overlap. For example, the second substrate tab protective tape 370_2 may be formed to be larger than the area where the second substrate tab 360_2 and the other side 300_2 of the substrate overlap each other, so as to protrude beyond the area.

In FIGS. 3 and 4, the widths of the protective tape 340 and the insulating tape 350 are illustrated as corresponding to the width of the substrate, but is not limited thereto, and the width of the protective tape 340 may be larger or smaller than the width of the substrate.

In addition, in FIGS. 3 and 4, the insulating tape 350 is illustrated as being between the protective tape 340 and the coated portion 310, but is not limited thereto, and the position of the insulating tape 350 may be appropriately changed to correspond to the position of the end line (E) where the end of the other substrate is arranged.

Through this configuration, the stability and life characteristics of a secondary battery may be improved by preventing or reducing the occurrence of wrinkles or folds in the semi-coated portion 330 located at the center of the winding during the core extraction process or the pressing process of an electrode assembly by using the protective tape 340.

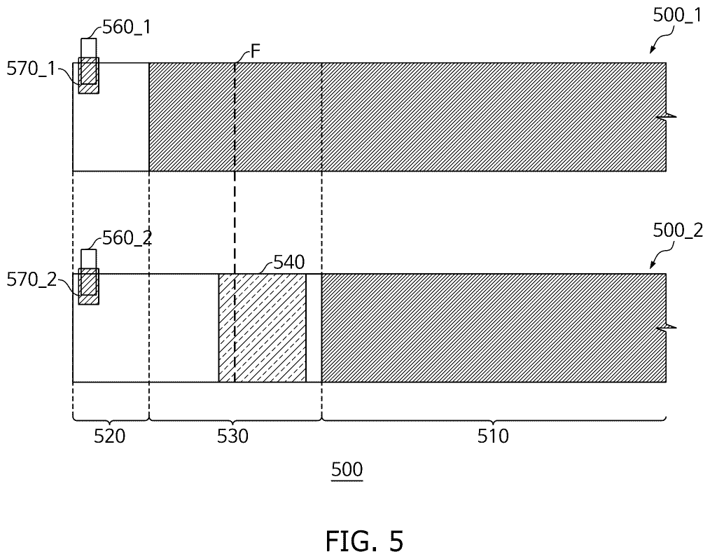

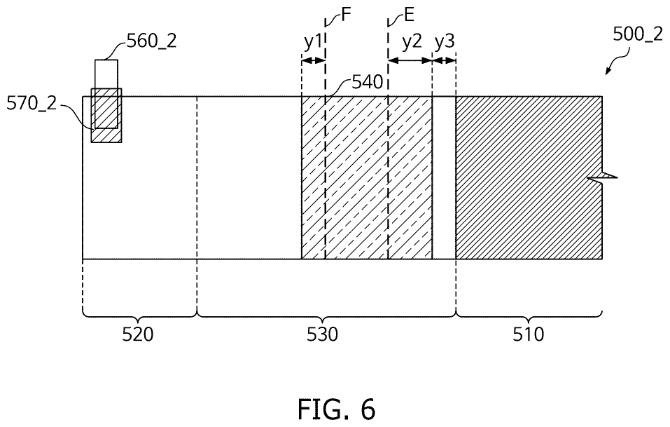

FIG. 5 is a diagram showing an example of an electrode 500 according to one or more embodiments of the present disclosure, and FIG. 6 is an enlarged view of the protective tape 540 shown in FIG. 5 according to one or more embodiments of the present disclosure. In the description with reference to FIGS. 5 and 6, configurations described or duplicate descriptions with reference to FIGS. 1 to 4 are not provided.

Referring to FIGS. 5 and 6, the electrode 500 may include a coated portion 510 in which an active material is applied to both sides (e.g., opposite sides) of the substrate, a semi-coated portion 530 in which the active material is applied to only one side of the substrate, and a non-coated portion 520 in which the active material is not applied to the both sides (e.g., opposite sides) of the substrate. The non-coated portion 520 is at the tip of the substrate, and the semi-coated portion 530 may be between the coated portion 510 and the non-coated portion 520. For convenience of explanation, with respect to the semi-coated portion 530 in the drawing, a direction in which the coated portion 510 is arranged is defined as the right side and a direction in which the non-coated portion 520 is arranged is defined as the left side. For example, the non-coated portion 520 may be referred to as the left side and the coated portion 510 may be referred to as the right side.

In one or more embodiments, a protective tape 540 may be attached to the other side 500_2 of the substrate in the semi-coated portion 530. The protective tape 540 may be attached to cover the folding line (F) along which the substrate is first folded. The protective tape 540 may be attached to cover an area within a set or certain length on each side of the folding line (F) in the longitudinal direction of the electrode.

In addition, the protective tape 540 may be attached to cover an end line (E) on which an end of another substrate is arranged on the other side 500_2 of the substrate in the semi-coated portion 530. For example, when the end line (E) is located between the folding line (F) and the coated portion 510, the protective tape 540 may be attached to cover an area spaced apart by a first length (y1) to the left of the folding line (F) and to cover an area spaced apart by a second length (y2) to the right of the end line (E). In one or more embodiments, when the end line (E) is between the folding line (F) and the non-coated portion 520, the protective tape 540 may be attached to cover an area spaced apart by a first length (y1) to the right of the folding line (F) and to cover an area spaced apart by a second length (y2) to the left of the end line (E). Here, the first length (y1) and the second length (y2) may each be less than or equal to 10 mm. Additionally, the first length (y1) and the second length (y2) may each be less than or equal to 5 mm. Here, the first length (y1) and the second length (y2) may be equal to or different from each other.

In one or more embodiments, the protective tape 540 may be attached away (e.g., may be spaced and/or apart (e.g., spaced apart)) from the coated portion so as not to interfere with the coated portion 510. Here, the distance (y3) by which the protective tape 540 is spaced from the coated portion 510 may be 10 mm or more, but is not limited thereto.

In one or more embodiments, the non-coated portion 520 may be connected to substrate tabs 560_1 and 560_2, and substrate tab protective tapes 570_1 and 570_2 may be attached on the substrate tabs 560_1 and 560_2, respectively. In one or more embodiments, the first substrate tab 560_1 may be connected to overlap on one side 500_1 of the substrate, and the first substrate tab protective tape 570_1 may be attached to cover the area where the first substrate tab 560_1 and the one side 500_1 of the substrate overlap. In addition, the first substrate tab protective tape 570_1 may be formed to be larger than the area where the first substrate tab 560_1 and one side of the substrate 500_1 overlap each other, so as to protrude beyond the area.

Through this configuration, the protective tape 540 may be attached to cover not only the folding line (F) along which the substrate is first folded, but also the end line (E) where the end of another substrate is arranged on the other side 500_2 of the substrate. For example, the protective tape 540 may be configured to cover the folding line (F) along which the substrate is first folded and to cover the end line (E) where the end of another substrate is arranged on the other side 500_2 of the substrate. Accordingly, the insulating tape may not be provided, the tape attachment process is simplified, and the cost of the secondary battery manufacturing process may be reduced.

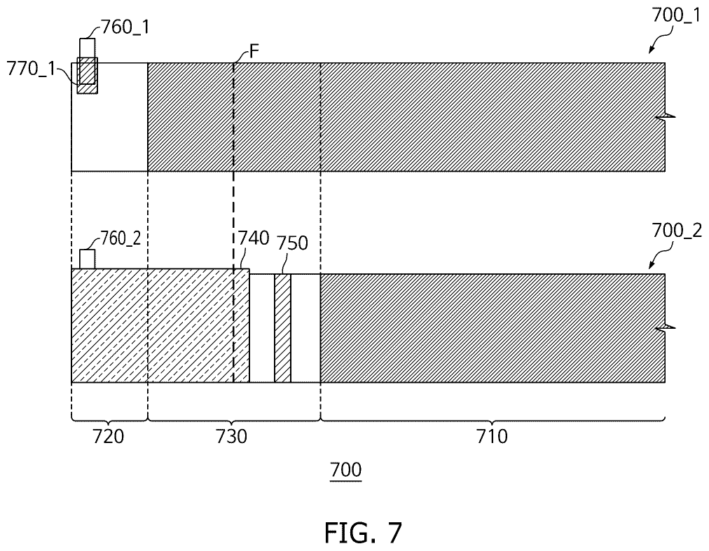

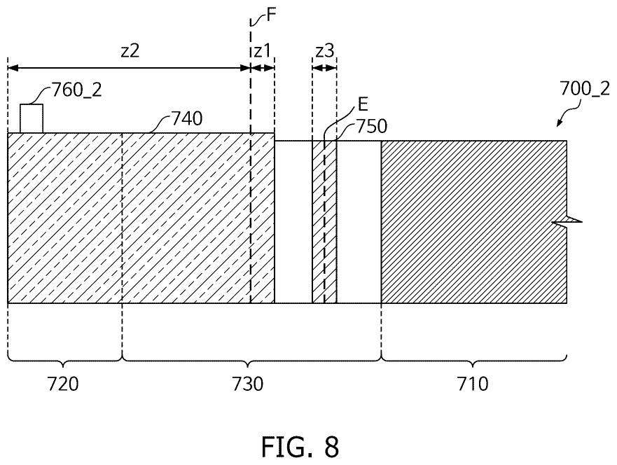

FIG. 7 is a diagram showing an example of an electrode 700 according to one or more embodiments of the present disclosure, and FIG. 8 is an enlarged view of the protective tape 740 shown in FIG. 7 according to one or more embodiments of the present disclosure. In the description with reference to FIGS. 7 and 8, configurations described or duplicate descriptions with reference to FIGS. 1 to 6 may not be provided.

Referring to FIGS. 7 and 8, the electrode 700 may include a coated portion 710 in which an active material is applied to both sides (e.g., opposite sides) of the substrate, a semi-coated portion 730 in which the active material is applied to only one side of the substrate, and a non-coated portion 720 in which the active material is not applied to the both sides (e.g., opposite sides) of the substrate. The non-coated portion 720 is at the tip of the substrate, and the semi-coated portion 730 may be between the coated portion 710 and the non-coated portion 720. For convenience of explanation, with respect to the semi-coated portion 730 in the drawing, a direction in which the coated portion 710 is arranged is defined as the right side and a direction in which the non-coated portion 720 is arranged is defined as the left side. For example, the non-coated portion 720 may be referred to as the left side and the coated portion 710 may be referred to as the right side.

In one or more embodiments, a protective tape 740 may be attached to the other side 700_2 of the substrate in the semi-coated portion 730. The protective tape 740 may be attached to cover the folding line (F) where the substrate is first folded. The protective tape 740 may be attached to cover an area within a set or certain length on each side of the folding line (F) in the longitudinal direction of the electrode.

In one or more embodiments, the non-coated portion 720 may be connected to the substrate tabs 760_1 and 760_2. For example, a first substrate tab 760_1 may be overlapped and connected to one side 700_1 of the substrate of the non-coated portion 720, and a second substrate tab 760_2 may be overlapped and connected to the other side 700_2 of the substrate of the non-coated portion 720.

In one or more embodiments, a protective tape 740 may be attached to cover the second substrate tab 760_2. For example, the protective tape 740 may be attached to cover an area spaced and/or apart (e.g., spaced apart) by a first length (z1) to the right of the folding line (F) and to cover an area spaced and/or apart (e.g., spaced apart) by a second length (z2) to the left of the folding line (F). In this case, the second length (z2) may be extended to the position where the second substrate tab 760_2 is placed. For example, the protective tape 740 may be extended to protrude beyond the area where the second substrate tab 760_2 and the other side 700_2 of the substrate overlap. Here, the first length (z1) may be less than or equal to 10 mm. Additionally, the first length (z1) may be less than or equal to 5 mm.

In one or more embodiments, an insulating tape 750 may be attached to the other side 700_2 of the substrate in the semi-coated portion 730. An end line (E) on which an end of another substrate facing the corresponding substrate is arranged may be positioned in the semi-coated portion 730, and an insulating tape 750 may be attached to cover the end line (E). The length (z3) of the insulating tape 750 may be less than or equal to 10 mm, but is not limited thereto.

In one or more embodiments, the insulating tape 750 may be attached to cover an area within a set or certain length on each side of the end line (E). For example, the insulating tape 750 may be attached to cover an area less than or equal to 5 mm on each side of the end line (E), but is not limited thereto.

In FIGS. 7 and 8, the insulating tape 750 is illustrated as being between the protective tape 740 and the coated portion 710, but this is not limited thereto, and the position of the insulating tape 750 may be appropriately changed to correspond to the position of the end line (E) where the end of another substrate is placed, and accordingly, the shapes and positions of the protective tape 740 and the insulating tape 750 may also be appropriately changed. For example, when the end line (E) is located to the left of the folding line (F), the insulating tape 750 may not be provided, and the end line (E) may be covered by the protective tape 740. In addition, even if (e.g., when) the end line (E) is located to the right of the folding line (F), the protective tape 740 may be extended to the position of the end line (E) and the insulating tape 750 may not be provided.

In FIGS. 7 and 8, the protective tape 740 is shown as being extended to protrude a certain amount from the substrate in the width direction of the substrate, but the shape of the protective tape 740 is not limited thereto. For example, the protective tape 740 may protrude from the substrate in the width direction only in the portion covering the substrate tabs 760_1 and 760_2, and may correspond to the width of the substrate in the remaining portions.

In addition, in FIGS. 7 and 8, the protective tape 740 is extended to the end of the substrate, but is not limited thereto, and the protective tape 740 may be extended to protrude only a set or certain length beyond the area where the second substrate tab 760_2 and the other side 700_2 of the substrate overlap.

Through this configuration, the protective tape 740 may be attached to cover not only the folding line (F) along which the substrate is first folded, but also the second substrate tab 760_2 connected on the other side 700_2 of the substrate. For example, the protective tape 740 may be configured to cover the folding line (F) along which the substrate is first folded and to cover the second substrate tab 760_2 connected to the other side 700_2 of the substrate. Accordingly, the substrate tab protective tape may not be provided, so that the tape attachment process is simplified and the cost of the secondary battery manufacturing process may be reduced.

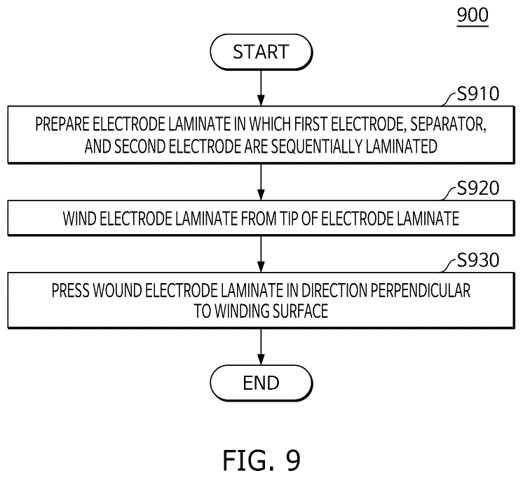

FIG. 9 is a flowchart 900 illustrating a method of manufacturing an electrode assembly according to one or more embodiments of the present disclosure. A method of manufacturing an electrode assembly may be initiated by preparing an electrode laminate in which a first electrode, a separator, and a second electrode are sequentially laminated (S910).

Then, the prepared electrode laminate may be wound from the tip of the electrode laminate (S920). Then, the wound electrode laminate may be pressed in a direction perpendicular to the winding surface (S930).

Here, the first electrode may include a substrate, a coated portion in which an active material is applied to both sides (e.g., opposite sides) of the substrate, a non-coated portion which is at a tip of the substrate, and in which the both sides (e.g., opposite sides) of the substrate are exposed, and a semi-coated portion which is between the coated portion and the non-coated portion, and includes one side in which the active material is applied to only one side of the substrate.

In one or more embodiments, a folding line, along which the substrate is first folded when the electrode laminate is wound, may be on the semi-coated portion of the first electrode. Accordingly, a protective tape to cover the folding line may be attached to the other side of the substrate in the semi-coated portion of the prepared electrode laminate, in which the substrate is exposed.

In one or more embodiments, the protective tape may be attached to cover an area less than or equal to 10 mm on each side of the folding line in the longitudinal direction of the electrode. In addition, the protective tape may be attached to cover an area less than or equal to 5 mm on each side of the folding line in the longitudinal direction of the electrode.

In one or more embodiments, the protective tape may be attached away (e.g., spaced and/or apart (e.g., spaced apart)) from the coated portion. In this case, the distance by which the protective tape is separated from the coated portion may be 10 mm or more.

In one or more embodiments, an end line, in which an end of the second electrode facing the first electrode is arranged, may be located in the semi-coated portion. The protective tape may be attached to cover the end line. In addition, a substrate tab may be connected to the non-coated portion of the first electrode, and a protective tape may be attached to cover the substrate tab.

In one or more embodiments, at least a portion of the protective tape may include (e.g., may be composed of) an insulating material. In addition, at least a portion of the protective tape includes (e.g., is made of) PI or PET material.

The flow chart of FIG. 9 and the description above are only examples of the present disclosure, and the scope of the present disclosure is not limited to the flow chart of FIG. 9 and the description above. For example, one or more steps in the flowchart and/or the descriptions above may be added, changed, or deleted, the order of one or more steps may be changed, and one or more steps may be performed simultaneously.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

### DESCRIPTION OF SOME REFERENCE SYMBOLS

10: battery cell
100: electrode assembly
110: electrode laminate
112: first electrode
114: second electrode
116: separator
130: substrate tab
130_1: first substrate tab
130_2: second substrate tab
142: first lead tab
144: second lead tab
146: tab film
150: case

What is claimed is:

1. An electrode comprising:
a substrate;
a coated portion comprising an active material on opposite sides of the substrate;
a non-coated portion at a tip of the substrate where the opposite sides of the substrate are exposed; and
a semi-coated portion between the coated portion and the non-coated portion, and comprising the active material on one side of the substrate,
wherein a protective tape is attached to the other side of the substrate in which the substrate is exposed in the semi-coated portion.

2. The electrode according to claim 1, wherein
a folding line along which the substrate is configured to be first folded is located in the semi-coated portion, and
the protective tape is attached to cover the folding line.

3. The electrode according to claim 2, wherein
the protective tape is attached to cover an area less than or equal to 10 mm on each side of the folding line in a longitudinal direction of the electrode.

4. The electrode according to claim 2, wherein
the protective tape is attached to cover an area less than or equal to 5 mm on each side of the folding line in a longitudinal direction of the electrode.

5. The electrode according to claim 2, wherein
an end line, in which an end of another substrate facing the substrate is located, is in the semi-coated portion, and
the protective tape is attached to cover the end line.

6. The electrode according to claim 5, wherein the protective tape is spaced from the coated portion.

7. The electrode according to claim 6, wherein the protective tape is spaced from the coated portion by 10 mm or more.

8. The electrode according to claim 5, wherein an insulating tape is on the other side of the substrate in which the substrate is exposed in the semi-coated portion between the protective tape and the coated portion.

9. The electrode according to claim 2, wherein a substrate tab is connected to the non-coated portion, and
the protective tape is attached to cover the substrate tab.

10. The electrode according to claim 2, wherein at least a portion of the protective tape comprises an insulating material.

11. The electrode according to claim 10, wherein at least a portion of the protective tape comprises a polyimide (PI) material or a polyethylene terephthalate (PET) material.

12. An electrode assembly comprising:
a first electrode;
a second electrode; and
a separator between the first electrode and the second electrode,
wherein the first electrode, the separator, and the second electrode are wound in a sequentially stacked state, and
wherein the first electrode includes a substrate, a coated portion comprising an active material on opposite sides of the substrate, a non-coated portion at a tip of the substrate, and where the opposite sides of the substrate are exposed, and a semi-coated portion between the coated portion and the non-coated portion, and comprising the active material on one side of the substrate, and
a protective tape is attached to the other side of the substrate in which the substrate is exposed in the semi-coated portion.

13. The electrode assembly according to claim 12, wherein a folding line along which the substrate is configured to be first folded is located in the semi-coated portion, and
the protective tape is attached to cover the folding line.

14. The electrode assembly according to claim 13, wherein the protective tape is attached to cover an area less than or equal to 10 mm on each side of the folding line in a longitudinal direction of the electrode.

15. The electrode assembly according to claim 12, wherein an end line, in which an end of the second electrode facing the first electrode is located, is in the semi-coated portion, and
the protective tape is attached to cover the end line.

16. The electrode assembly according to claim 12, wherein a substrate tab is connected to the non-coated portion of the first electrode, and
the protective tape is attached to cover the substrate tab.

17. A method of manufacturing an electrode assembly, comprising:
preparing an electrode laminate in which a first electrode, a separator, and a second electrode are sequentially stacked;
winding the electrode laminate from a tip of the electrode laminate to form a wound electrode laminate; and
pressing the wound electrode laminate in a direction perpendicular to a winding surface,
wherein the first electrode comprises a substrate, a coated portion comprising an active material on opposite sides of the substrate, a non-coated portion at a tip of the substrate, and where the opposite sides of the substrate are exposed, and a semi-coated portion between the coated portion and the non-coated portion, and comprising the active material on one side of the substrate, and
wherein the method further comprises attaching a protective tape to the other side of the substrate in which the substrate is exposed in the semi-coated portion, before the preparing the electrode laminate.

18. The method of manufacturing an electrode assembly according to claim 17, wherein
in the winding of the electrode assembly, a folding line along which the substrate is first folded is on the semi-coated portion of the first electrode, and
the protective tape is attached to cover the folding line.

19. The method of manufacturing an electrode assembly according to claim 17, wherein in the preparing of the electrode laminate,
an end line, in which an end of the second electrode facing the first electrode is located, is in the semi-coated portion, and
the protective tape is attached to cover the end line.

20. The method of manufacturing an electrode assembly according to claim 17, wherein
a substrate tab is connected to the non-coated portion of the first electrode, and
the protective tape is attached to cover the substrate tab.
